(19) United States
(12) Patent Application Publication
(10) Pub. No.: US 2026/0296152 A1
(43) Pub. Date: Oct. 1, 2026

(54) ADAPTER FOR TELESCOPIC BEAMS

(71) Applicant: Worksport Ltd., Vaughan (CA)

(72) Inventors: Ajeethkumar Angappan, Brampton (CA); James G. Quintus, Nixa, MO (US)

(73) Assignee: Worksport Ltd., Vaughan, ON (CA)

(21) Appl. No.: 19/476,533

(22) PCT Filed: Apr. 18, 2024
(86) PCT No.: PCT/US2024/025192

§ 371 Date: Oct. 17, 2025

Related U.S. Application Data
(60) Provisional application No. 63/496,994, filed on Apr. 19, 2023.

(51) Int. Cl. B60J 7/10; F16B 7/10

(52) U.S. Cl. CPC B60J 7/102; F16B 7/105

(57) ABSTRACT

An adapter for coupling a straight inner beam and a curved outer beam is provided. The adapter includes a u-shaped body, inner snap pins, and outer snap pins. The u-shaped body includes a horizontal side and vertical sides forming a channel mating with the inner beam at an interior side of the u-shaped body, and mating with the outer beam at an exterior side of the u-shaped body. At least one of the inner snap pins is arranged on an interior face of each vertical side. Each inner snap pin engages with one of the inner pin such that the u-shaped body is secured to the inner beam. At least one of the outer snap pins is arranged on an exterior face of each vertical side. Each outer snap pin engages with one of the outer pin holes such that the u-shaped body is secured to the outer beam.

### CROSS-REFERENCE TO RELATED APPLICATIONS

This application claims priority to U.S. Provisional Patent Application No. 63/496,994, filed Apr. 19, 2023, and entitled “Adapter for Telescopic Beams,” the entirety of which is incorporated herein by reference.

### FIELD OF THE DISCLOSURE

The present disclosure is generally directed to an adapter for telescopic beams, and more specifically, to an adapter configured to couple an inner, straight telescopic beam to an outer, curved telescopic beam.

### BACKGROUND

Tonneau cover assemblies for pickup trucks typically include a cover (such as a tarp) arranged over a frame. The frame typically includes a plurality of crossbeams mechanically coupled to perimeter members of the frame for the purpose of providing structural support to the overall frame structure. In some examples, such as disclosed in U.S. patent application Ser. No. 17/896,287, the crossbeam assemblies may be adjustable. These adjustable crossbeam assemblies typically include a pair of straight telescoping beams enabling a user to adjust the width of the frame to conform to various truck bed sizes, as well as to allow the frame to be shipped in a collapsed state. Current adjustable crossbeam assemblies are incapable of providing upward, vertical support for the cover arranged over the frame. This lack of support can lead to water pooling on the cover in wet conditions. While curved crossbeam assemblies may provide this upward, vertical support to the cover, currently available curved crossbeam assemblies are not adjustable. Further, the currently available adjustable crossbeam assemblies often rely on fasteners and clearance between the telescopic beams, which may be susceptible to rattling when the truck is in motion.

### SUMMARY OF THE DISCLOSURE

The present disclosure is generally directed to an adapter for mechanically coupling to an inner, preferably straight, beam and an outer, preferably curved, beam to form an adjustable crossbeam assembly for a tonneau cover frame. The adapter is substantially an inverted u-shape, having a horizontal side and a pair of vertical sides forming a channel capable of receiving the inner beam. A plurality of inner snap pins is arranged on interior faces of the vertical sides of the adapter, while a plurality of outer snap pins is arranged on exterior faces of the vertical sides. The inner snap pins are configured to engage with at least one of a plurality of inner pin holes of the inner beam, while the outer snap pins are configured to engage with at least one of a plurality of outer pin holes of the outer beam. The curved outer beam provides a vertical support force on a cover affixed to the tonneau cover frame to prevent water from pooling on the cover. Further, the plurality of pin holes on the inner beam enables the adjustability of the crossbeam assembly, while eliminating the susceptibility to rattling of previous adjustable configurations.

In a non-limiting example tonneau cover assembly utilizing the aforementioned adapters, a first inner beam is configured to mechanically couple to a first perimeter member on one side of the tonneau cover frame. The first inner beam is then coupled to a first adapter via the inner pin holes of the first inner beam and the inner snap pins of the first adapter. The first adapter then couples to an outer beam via a first set of outer pin holes at a first end of the outer beam and the outer snap pins of the first adapter. The outer beam is then coupled to a second adapter via a second set of outer pin holes at a second end of the outer beam and the outer snap pins of the second adapter. The second adapter then couples to a second inner beam via the inner pin holes of the second beam and the inner snap pins of the second adapter. The second beam then mechanically couples to a second perimeter member on an opposite side of the tonneau cover frame. The width of the tonneau cover frame may be adjusted by changing the position of the first or second adapter relative to the first or second inner beams. Preferably, the inner beams are of equal length, and each of the inner beams are about half as long as the outer beam.

Preferably, the exterior face of each vertical side of the adapter includes at least two outer snap pins vertically offset from each other. This vertical offset enables engagement with the outer pin holes of the curved outer beam. Further, the inner beam may include five or more inner pin holes depending on the range of adjustability desired. The inner snap pins may be substantially dome-shaped, hemispheric, or frustoconical, while the outer snap pins may be shaped as a truncated cylinder or a cylindrical segment having an angled top face.

Preferably, when the outer snap pins of the adapter are disengaged from the outer pin holes of the outer beam, the vertical sides of the adapter meet the horizontal side of the adapter at an angle greater than ninety degrees, such as in a range from 92 degrees to 110 degrees. When the outer snap pins of the adapter engage with the outer pin holes of the outer beam, the outer beam biases the vertical sides of the adapter towards the inner beam, resulting in the angle being reduced to about ninety degrees.

Preferably, the adapter is a monolithic, plastic structure formed by injection molding, additive manufacturing, or any other practical manufacturing process. Accordingly, the adapter has a degree of flexibility, allowing the vertical sides of the adapter to be biased or pinched towards the inner beam by the outer beam. By contrast, the outer and inner beams are substantially rigid metal.

Generally, in one example, an adapter for coupling an inner beam and an outer beam is provided. The outer beam has an inner width that is greater than an outer width of the inner beam. The inner beam may be a straight telescopic beam. The outer beam may be a curved telescopic beam.

The adapter includes an inverted u-shaped body. The inverted u-shaped body includes a horizontal side and a pair of vertical sides forming a channel. The channel is configured to mate and align with the inner beam at an interior side of the inverted u-shaped body. The channel is further configured to mate and align with the outer beam at an exterior side of the inverted u-shaped body.

The adapter further includes a plurality of inner snap pins. At least one of the plurality of inner snap pins is arranged on an interior face of each of the pair of vertical sides of the inverted u-shaped body. Each of the plurality of inner snap pins is configured to engage with one of a plurality of inner pin holes of the inner beam such that the inverted u-shaped body is secured to the inner beam. According to an example, the plurality of inner snap pins is substantially dome-shaped.

The adapter further includes a plurality of outer snap pins. At least one of the plurality of outer snap pins is arranged on an exterior face of each of the pair of vertical sides of the inverted u-shaped body. Each of the plurality of outer snap pins is configured to engage with one of a plurality of outer pin holes of the outer beam such that the inverted u-shaped body is secured to the outer beam. According to an example, a top face of each of the plurality of outer snap pins may be angled relative to a corresponding one of the pair of vertical sides. According to a further example, two or more of the plurality of outer snap pins are arranged on one of the pair of vertical sides. The two or more of the plurality of outer snap pins may be vertically offset from each other to accommodate a curve of the curved telescopic beam.

According to an example, the pair of vertical sides of the inverted u-shaped body meet the horizontal side at an angle greater than ninety degrees when the plurality of outer snap pins are disengaged from the plurality of the outer pin holes. Said angle between the horizontal side and each of the pair of vertical sides may be about 92 degrees to about 110 degrees.

According to an example, the adapter may further include one or more ramps on an exterior face of the horizontal side of the inverted u-shaped body. The one or more ramps may have an angle corresponding to a curve of the curved telescopic beam.

Generally, in another example, a crossbeam assembly is provided. The crossbeam assembly includes a straight telescopic beam. The straight telescopic beam includes a plurality of inner pin holes.

The crossbeam assembly further includes a curved telescopic beam. The curved telescopic beam further includes a plurality of outer pin holes.

The crossbeam assembly further includes an adapter. According to an example, the adapter is a monolithic structure. The adapter may be formed by injection molding or additive manufacturing. The adapter may be substantially plastic.

The adapter includes an inverted u-shaped body. The inverted u-shaped body includes a horizontal side and a pair of vertical sides forming a channel. The channel is configured to mate and align with the straight telescopic beam at an interior side of the inverted u-shaped body. The channel is further configured to mate and align with the curved telescopic beam at an exterior side of the inverted u-shaped body.

The adapter further includes a plurality of inner snap pins. At least one of the plurality of inner snap pins is arranged on an interior face of each of the pair of vertical sides of the inverted u-shaped body. Each of the plurality of inner snap pins is configured to engage with one of the plurality of inner pin holes such that the inverted u-shaped body is secured to the straight telescopic beam.

The adapter further includes a plurality of outer snap pins. At least one of the plurality of outer snap pins is arranged on an exterior face of each of the pair of vertical sides of the inverted u-shaped body. Each of the plurality of outer snap pins is configured to engage with one of the plurality of outer pin holes such that the inverted u-shaped body is secured to the curved telescopic beam.

According to an example, the pair of vertical sides of the inverted u-shaped body meet the horizontal side at an angle greater than ninety degrees when the plurality of outer snap pins are disengaged from the plurality of the outer pin holes. The curved telescopic beam is configured to bias the pair of vertical sides of the inverted u-shaped body towards the straight telescopic beam such that the angle between the horizontal side and each of the pair of vertical sides is about ninety degrees.

According to an example, the straight telescopic beam and the curved telescopic beam are substantially metal. A length of the straight telescopic beam may be substantially half of a length of the curved telescopic beam. The straight telescopic beam may be configured to mechanically couple to a tonneau cover frame. The curved telescopic beam may be substantially u-shaped. The curved telescopic beam may have an open lower face for receiving the inverted u-shaped body of the adapter.

According to an example, two or more of the plurality of outer snap pins are vertically offset from each other. Two or more of the plurality of outer pin holes may be vertically offset from each other to correspond to the vertically offset two or more of the plurality of outer snap pins.

Generally, in another aspect, a tonneau cover assembly is provided. The tonneau cover assembly includes a frame. The frame includes at least one crossbeam assembly as recited above. The curved telescopic beam of the at least one crossbeam assembly provides vertical support for a tonneau cover affixed to the frame.

Generally, in another aspect, a method for manufacturing a crossbeam assembly is provided. The method includes mating and aligning a straight telescopic beam with an interior side of a channel of an inverted u-shaped body of an adapter. The straight telescopic beam includes a plurality of inner pin holes.

The method further includes engaging at least one of a plurality of inner snap pins of the inverted u-shaped body with at least one of the plurality of inner pin holes. At least one of the plurality of inner snap pins are arranged on an interior face of each of a pair of vertical sides of the inverted u-shaped body such that the inverted u-shaped body is secured to the straight telescopic beam.

The method further includes mating and aligning an exterior side of the inverted u-shaped body of the adapter with a curved telescopic beam. The curved telescopic beam comprises a plurality of outer pin holes.

The method further includes engaging at least one of a plurality of outer snap pins of the inverted u-shaped body with at least one of the plurality of outer pin holes. At least one of the plurality of outer snap pins are arranged on an exterior face of each of the pair of vertical sides of the inverted u-shaped body such that the inverted u-shaped body is secured to the curved telescopic beam.

According to an example, upon engaging the at least one of the plurality of outer snap pins of the inverted u-shaped body with the at least one of the plurality of outer pin holes, the curved telescopic beam biases the pair of vertical sides of the inverted u-shaped body towards the straight telescopic beam.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an isometric view of a tonneau cover assembly, according to aspects of the present disclosure.

FIG. 2 is an isometric view of a tonneau cover assembly having a cover, according to aspects of the present disclosure.

FIG. 3 is a lower isometric view of an adapter for coupling an inner beam and an outer beam, according to aspects of the present disclosure.

FIG. 4 is an upper isometric view of the adapter of FIG. 2, according to aspects of the present disclosure.

FIG. 5 is an isometric view of an inner beam, according to aspects of the present disclosure.

FIG. 6 is an isometric view of an outer beam, according to aspects of the present disclosure.

FIG. 7 is an isometric view of an inner beam and an adapter for coupling the inner beam and an outer beam, according to aspects of the present disclosure.

FIG. 8 is an isometric view of an adapter mated to and aligned with an inner beam, according to aspects of the present disclosure.

FIG. 9 is a further isometric view of the adapter and inner beam of FIG. 8, according to aspects of the present disclosure.

FIG. 10 is a front view of the adapter and inner beam of FIG. 8, according to aspects of the present disclosure.

FIG. 11 is an isometric view of an inner beam, an adapter, and an outer beam, according to aspects of the present disclosure.

FIG. 12 is an isometric view of a crossbeam assembly, according to aspects of the present disclosure.

FIG. 13 is a front view of a crossbeam assembly, according to aspects of the present disclosure.

FIG. 14 is a flowchart of a method for manufacturing a crossbeam assembly, according to aspects of the present disclosure.

### DETAILED DESCRIPTION OF EMBODIMENTS

The present disclosure is generally directed to an adapter for mechanically coupling to an inner, preferable straight, beam and an outer, preferably curved, beam to form an adjustable crossbeam assembly for a tonneau cover frame. The adapter is substantially u-shaped, having a horizontal side and a pair of vertical sides forming a channel capable of receiving the inner beam. A plurality of inner snap pins is arranged on interior faces of the vertical sides of the adapter, while a plurality of outer snap pins is arranged on exterior faces of the vertical sides. The inner snap pins are configured to engage with at least one of a plurality of inner pin holes of the inner beam, while the outer snap pins are configured to engage with at least one of a plurality of outer pin holes of the outer beam. The curved outer beam provides a vertical support force on a cover of affixed to the tonneau cover frame to prevent water from pooling on the cover. Further, the plurality of pin holes on the inner beams enables the adjustability of the crossbeam assembly, while eliminating the susceptibility to rattling of previous adjustable configurations.

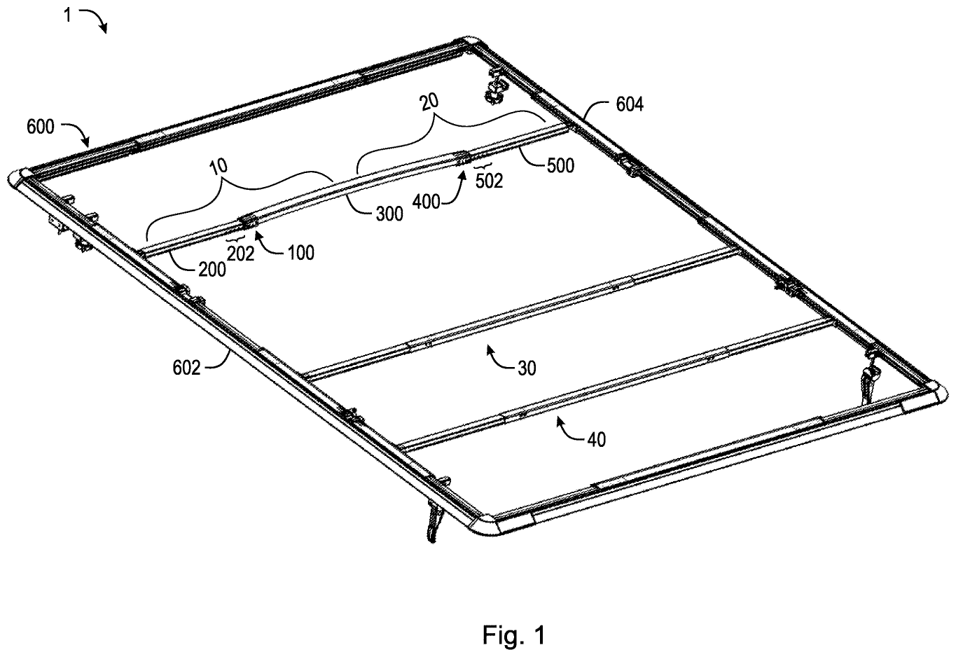

Turning now to the figures, FIG. 1 is an isometric view of a non-limiting example of a tonneau cover assembly 1. Broadly, the tonneau cover assembly 1 includes a frame 600 and one or more novel crossbeam assemblies 10, 20 to connect perimeter members 602, 604 of the frame 600. The tonneau cover assembly 10 may also include one or more conventional crossbeams 30, 40, though it is contemplated that the conventional crossbeams 30, 40 can be replaced by crossbeam assemblies according to embodiments of the current invention. The novel crossbeam assemblies 10, 20 and the conventional crossbeams 30, 40 are configured and arranged to provide structural support to the frame 600. In some examples, the conventional crossbeams 30, 40 may be adjustable telescoping beams. A first end of each conventional crossbeam 30, 40 is connected to a first perimeter member 602 of the frame 600, while a second end is connected to a second perimeter member 604 of the frame 600.

The tonneau cover assembly 1 shown in FIG. 1 includes two crossbeam assemblies 10, 20. The first crossbeam assembly 10 includes a first adapter 100 coupling one end of a first inner beam 200 to one end of an outer beam 300. The first inner beam 200 includes one or more inner pin holes 202 to couple the first adapter 100 to the first inner beam 200. The opposite end of the first inner beam 200 is then mechanically coupled to the first perimeter member 602. Similarly, the second crossbeam assembly 20 includes a second adapter 400 coupling one end of a second inner beam 500 to the opposite end of the outer beam 300. The second inner beam 500 includes one or more inner pin holes 502 to couple the second adapter 400 to the first inner beam 500. The opposite end of the second inner beam 500 is then mechanically coupled to the second perimeter member 604. These components are described in more detail with respect to the subsequent figures.

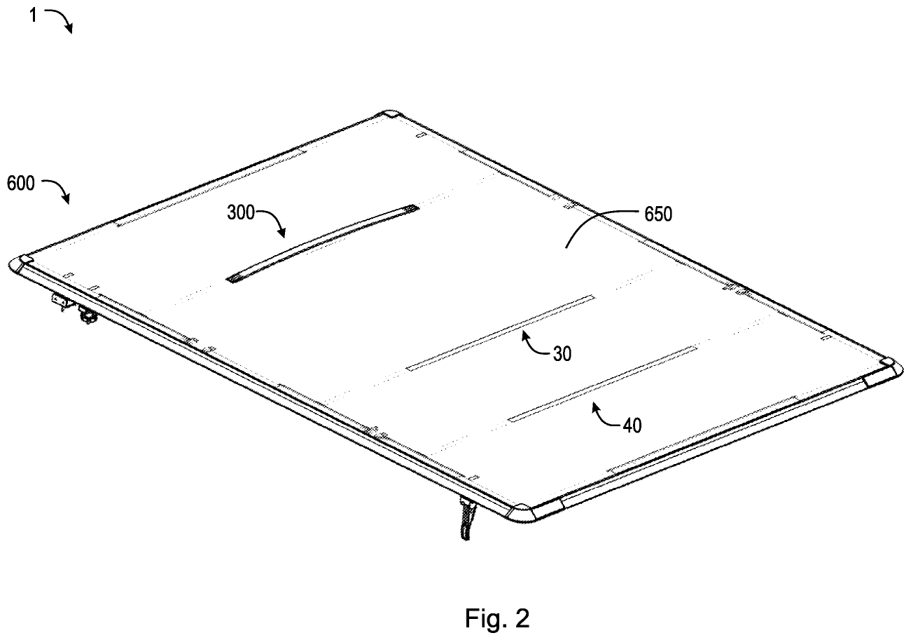

Still referring to FIG. 1, the outer beam 300 is depicted as a curved telescopic beam, while the first and second inner beams 200, 500 are depicted as straight telescopic beams. The curved nature of the outer beam 300 provides an upward, vertical force upon a cover 650 (such as a tarp) affixed to the frame 600. The result of the upward force is shown in FIG. 2, an isometric view of the tonneau cover assembly 1 with a cover 650 affixed to the frame 600. In some examples, the cover 650 may be manufactured from vinyl fabric or similar material. As can be seen in FIG. 1, in certain embodiments, each of the inner beams 200, 500 may have a length of about one-half of a length of the outer beam 300. Thus, as the inner beams 200, 500 may be of equal length, the outer beam 300 is horizontally centered relative to the frame 600, and the upward force from the curved outer beam 300 prevents water from pooling in the center portion of the cover 650. Further, the first and second inner beams 200, 500 each include a plurality of inner pin holes 202, 502 enabling lengthwise adjustment of each crossbeam assembly 10, 20. The details of this adjustment are described in more detail with respect to the subsequent figures.

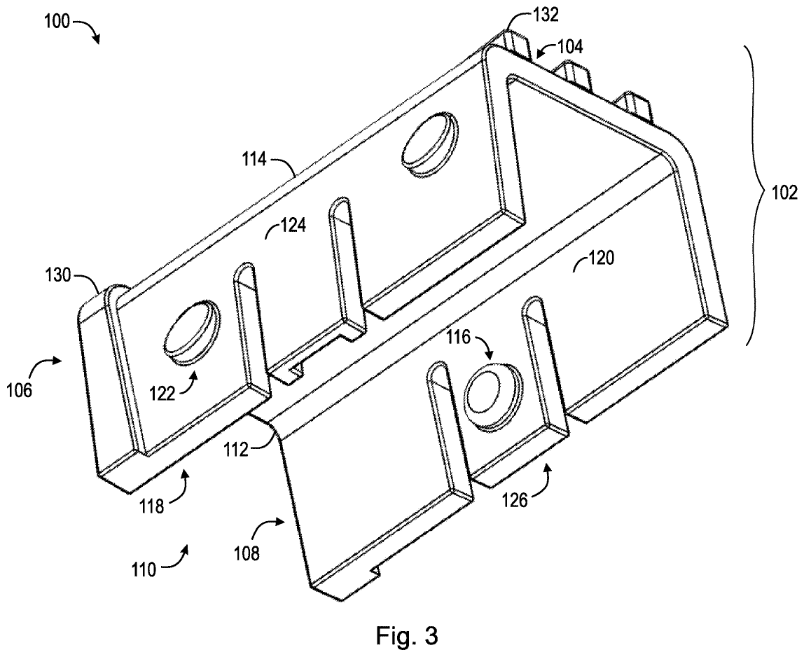

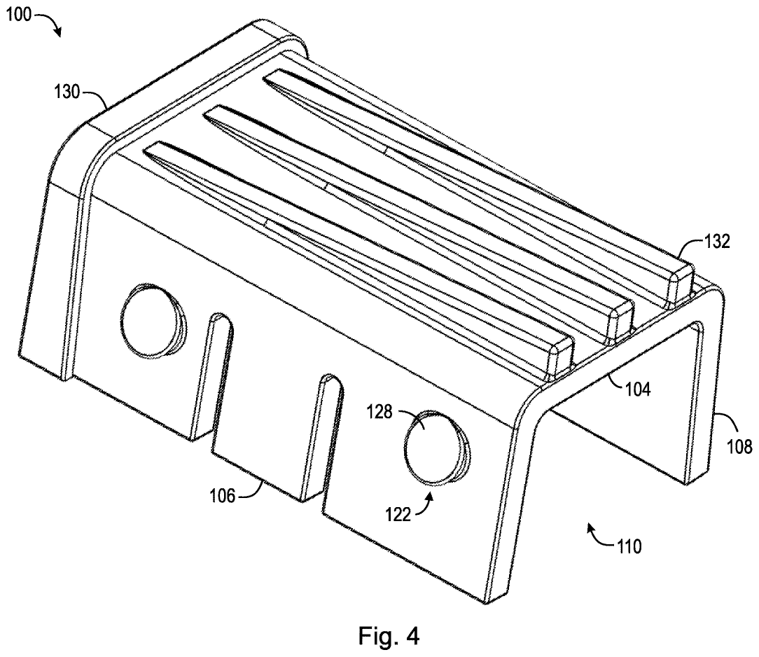

FIGS. 3 and 4 are isometric views of the adapter 100 referenced with respect to the first crossbeam assembly 10 shown in FIG. 1. Broadly, the adapter 100 includes an inverted u-shaped body 102. The inverted u-shaped body 102 may be defined by a horizontal side 104 and a pair of vertical sides 106, 108. Each vertical side 106, 108 may be defined by an interior face 118, 120 and an exterior face 124, 126. The horizontal side 104 and the vertical sides 106, 108 of the inverted u-shaped body 102 form a channel 110 with an interior side 112 and an exterior side 114. The channel 110 is shaped such that an inner beam 200 (as shown in FIG. 1) may fit within the channel 110 and then mate and align at the interior side 112 of the channel 110. Similarly, the channel 110 is shaped such that an outer beam 300 (as shown in FIG. 1) may fit around the channel 110 and then mate and align at the exterior side 114 of the channel 110.

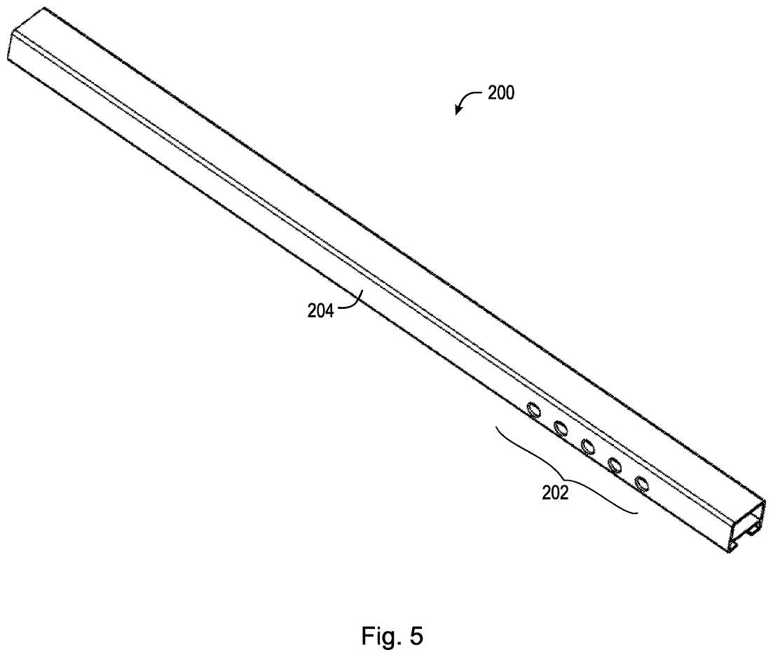

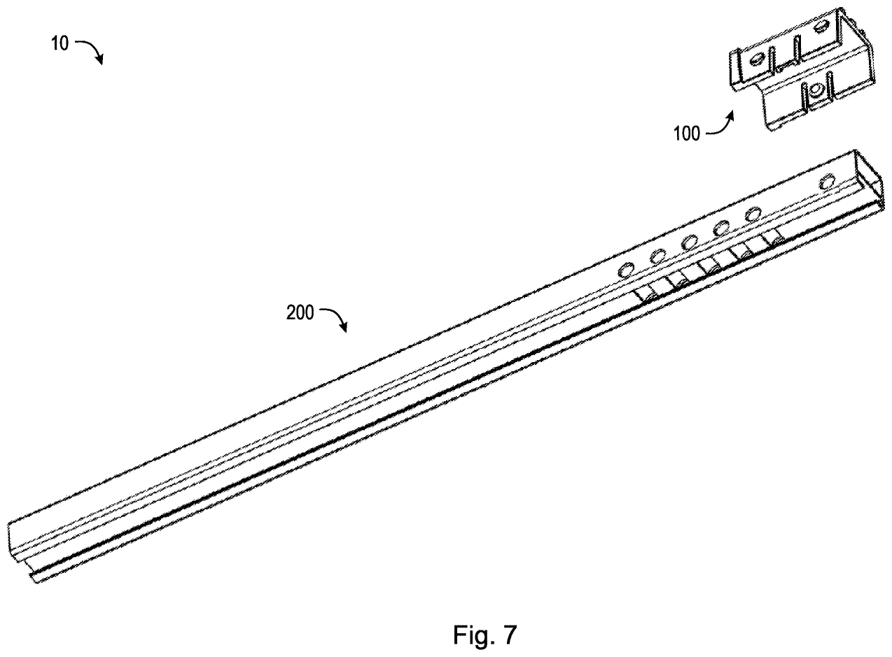

Critically, the adapter 100 includes two sets of snap pins 116, 122 enabling the adapter 100 to simultaneously couple with both the inner beam 200 and the outer beam 300. First, in certain embodiments, the adapter 100 includes one or more inner snap pins 116. Each inner snap pin 116 is configured to engage with an inner pin hole 202 of the inner beam 200. The inner pin holes 202 of the inner beam 200 are shown in more detail in FIGS. 5 and 7. Thus, by engaging the inner snap pin(s) 116 of the adapter 100 with different inner pin holes 202 of the inner beam 200, the overall length of the crossbeam assembly 10 may be adjusted. As shown in the non-limiting example of FIG. 3, inner face 120 of vertical side 108 includes one inner snap pin 116, though it is contemplated that each inner face 118, 120 of the vertical sides 106, 108 can include one inner snap pin 116. In yet further embodiments, each inner face 118, 120 may include two or more inner snap pins 116. In even further examples, only one of the inner faces 118, 120 includes an inner snap pin 116. As shown in the non-limiting example of FIG. 3, the inner snap pins 116 are substantially dome-shaped. The dome-shape of the inner snap pins 116 may enable easier engagement with the inner pin holes 202 when compared to purely cylindrical snap pins. In further examples, the inner snap pins 116 may be any other practical snap pin shape to improve engagement with the inner pin holes 202, which themselves may take any suitable shape.

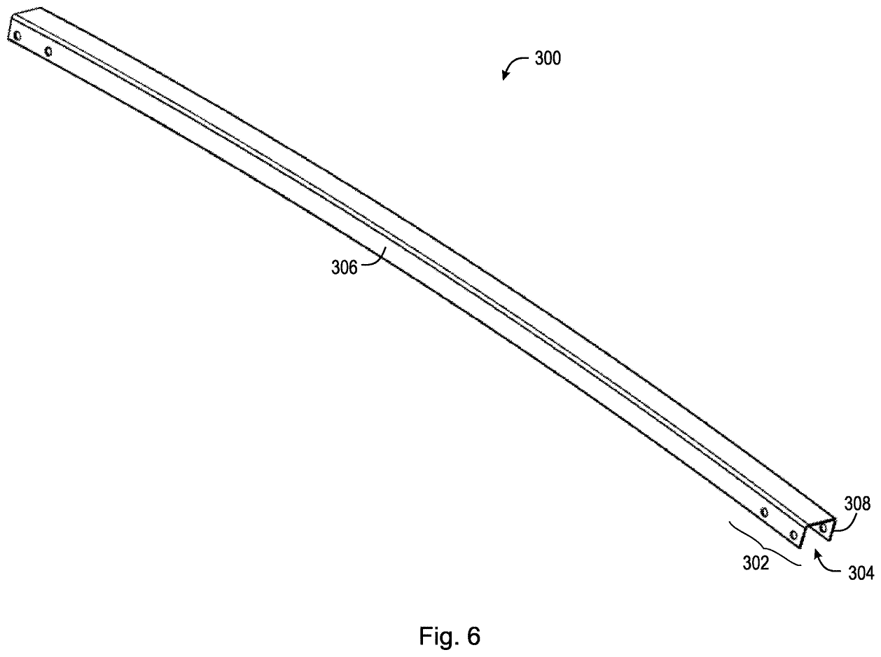

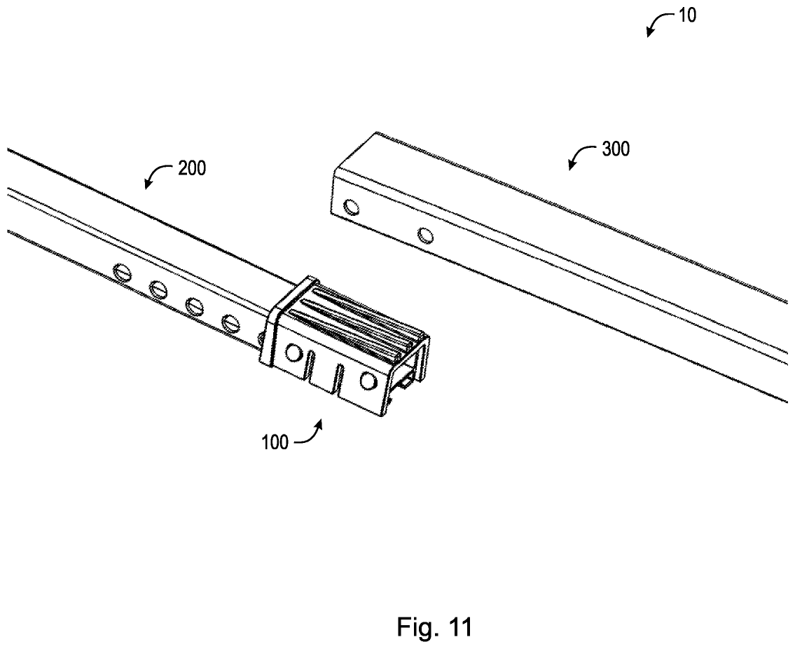

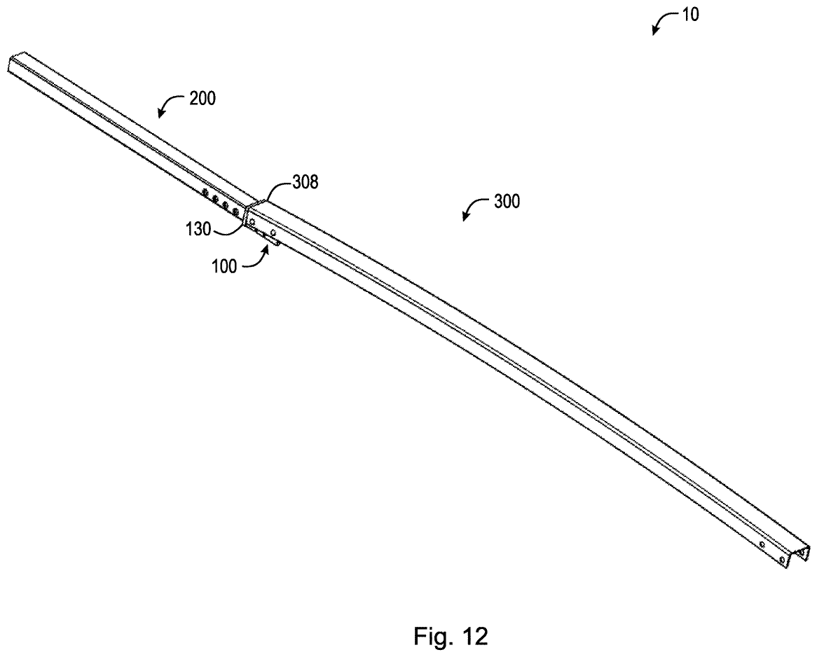

Second, the adapter 100 also includes a plurality of outer snap pins 122. Each of the outer snap pins 122 is configured to engage with an outer pin hole 302 of the outer beam 200. The outer pin holes 302 of the outer beam 300 are shown in more detail in FIGS. 6 and 11. As shown in the non-limiting examples of FIGS. 3 and 4, exterior face 124 of the vertical side 106 includes two outer snap pins 122, though it is contemplated that each exterior face 124, 126 of the vertical sides 106, 108 can include at least one, preferably at least two, outer snap pins 122. In the particular example of FIGS. 3 and 4, the two outer snap pins 122 may be vertically offset to enable coupling to a curved outer beam 300 (i.e., accounting for the curved nature of the curved outer beam 300). Further to this example, the lower outer snap pin 122 is configured to engage with the outer pin hole 302 closest to an end of the curved outer beam 300, and the upper outer snap pin 122 is configured to engage with the outer pin hole 302 furthest from the end of the curved outer beam 300, relative to only one end of the curved outer beam 300 (see FIG. 12). In further examples, each exterior face 124, 126 may include more or less than two outer snap pins 122.

As shown in the non-limiting examples of FIGS. 3 and 4, the outer snap pins 122 may include top faces 128 angled relative to the vertical sides 106, 108 of the adapter 100. The angled top faces 128 may enable easier engagement of the outer snap pins 122 with the outer pin holes 302 when compared to purely cylindrical snap pins. In one example, the top faces 128 may be angled at about 30-60 degrees relative, preferably about 45 degrees, relative to the vertical sides 106, 108, though any practical angle to improve engagement may be used. In further examples, the outer snap pins 122 may be any other practical snap pin shape to improve engagement with the outer pin holes 302, which themselves may take any suitable shape.

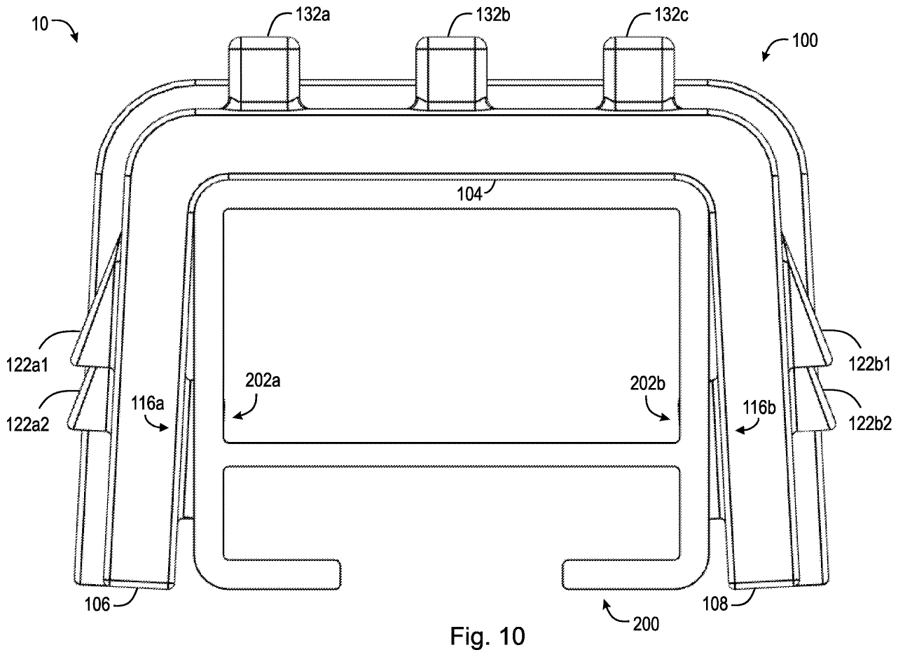

The non-limiting examples of FIGS. 3 and 4 depict an adapter 100 disengaged from both of the inner and outer beams 200, 300. When the adapter 100 is disengaged from the outer beam 300, vertical sides 106, 108 of the inverted u-shaped body 102 may meet the horizontal side 104 at an angle greater than ninety degrees, such as within a range of about 92 degrees to about 110 degrees (e.g., see FIG. 10). When the adapter 100 is coupled with the inner and outer beams 200, 300, pressure from the outer beam 300 biases the vertical sides 106, 108 inward towards the channel 110 and the inner beam 200. These biasing forces may result in the angles between the vertical sides 106, 108 and the horizontal side 104 to be about ninety degrees. Alternatively, when adapter 100 is disengaged from both of the inner and outer beams 200, 300, the vertical sides 106, 108 may meet the horizontal side 104 at an angle of about ninety degrees. Subsequent engagement with the inner beam 200 may bias the vertical sides 106, 108 outward to an angle greater than ninety degrees, such as within a range of about 92 degrees to about 110 degrees (e.g., see FIG. 10). Subsequent engagement with the outer beam 300 may then bias the vertical sides 106, 108 inward, such that the angles between the vertical sides 106, 108 and the horizontal side 104 to be about ninety degrees.

In any case, the biasing forces improve the strength of the coupling between the adapter 100, the inner beam 200, and the outer beam 300 by reinforcing the engagement between each set of snap pins 116, 122 and pin holes 202, 302, effectively “locking” the components of the crossbeam assembly 10 together. This “locking” is enabled by the flexibility of the adapter 100. In some examples, the adapter 100 may be substantially plastic and formed via injection molding or additive manufacturing, while the inner and outer beams 200, 300 are typically inflexible metal members.

The adapter 100 of FIGS. 3 and 4 may further include a plurality of ramps 132 arranged along the horizontal side 104 of the adapter 100. These ramps 132 are angled to correspond to a curve of the outer beam 300, and therefore provide additional structural support between the adapter 100 to the outer beam 300. While the non-limiting examples of FIGS. 3 and 4 depicts three ramps 132, any practical number of ramps 132 may be used. Further, the adapter 100 of FIGS. 3 and 4 may further include a lip 130. The lip 130 is configured to abut an end surface 308 (see FIG. 12) of the outer beam 300 when the outer beam 300 is coupled to the adapter 100. Accordingly, both the ramps 132 and the lip 130 may be used to provide additional structural and stabilizing support for the outer beam 300, further reinforcing the coupling of the outer beam 300 to the adapter 100.

FIG. 5 illustrates an example inner beam 200. As described above, the inner beam 200 is configured to mate and align with the interior side 112 of the channel 110 of the inverted u-shaped body 102 of the adapter 100 of FIGS. 3 and 4. Accordingly, an outer width of the inner beam 200 is narrower than an inner width of the channel 110 of the adapter 100. Necessarily, the width of the inner beam 200 will also be narrower than an outer beam 300 arranged around the exterior side 114 of the channel 110 of the inverted u-shaped body 102 of the adapter 100. Preferably, the inner beam 200 is formed of a substantially rigid and/or inflexible material, such as a hard metal.

As shown in the non-limiting example FIG. 5, the inner beam 200 includes five inner pin holes 202 on one or each horizontal side 204. Each of the inner pin holes 202 is configured to receive one of the inner snap pins 116 of the adapter 100 as shown in FIG. 3. In other examples, the inner beam 200 may include more or less than five inner pin holes 202 on one or each horizontal side 204. Including more than one inner pin hole 202 on one or each horizontal side 204 enables the lengthwise adjustability of the crossbeam assembly 10.

FIG. 6 illustrates an example of an outer beam 300. The outer beam 300 shown in FIG. 6 is curved to, in some examples, provide an upward support for a tonneau cover 650 (such as a tarp). As described above, the outer beam 300 is configured to mate and align with the exterior side 114 of the channel 110 of the inverted u-shaped body 102 of the adapter 100 of FIGS. 3 and 4. The outer beam 300 is able to mate and align with adapter 100 due to an open lower channel 304 configured to receive the inverted u-shaped body 102 of the adapter 100. Accordingly, an inner width of the outer beam 300 is wider than an outer width of the channel 110 of the adapter 100. Necessarily, the inner width of the outer beam 300 will also be larger than the outer width of the inner beam 200 arranged within the inverted u-shaped body 102 of the adapter 100. Preferably, the outer beam 300 is formed from a substantially rigid and/or inflexible material, such as a metal.

Still referring to FIG. 6, the outer beam 300 can include two outer pin holes 302 on each horizontal side 306, resulting in four total outer pin holes 302 proximate to the end surface 308. Alternatively, any number of outer pin holes 302, preferably at least two pin holes 302 on at least one horizontal side 306, may be used. Each of the outer pin holes 302 is configured to receive one of the outer snap pins 122 of the adapter 100 as shown in FIGS. 3 and 4. Further, the two outer pin holes 302 on one or each horizontal side 306 are vertically offset from each other to engage with the vertically offset outer snap pins 122 of FIGS. 3 and 4. As shown in FIG. 6, the outer pin hole 302 closest to the end surface 308 of the outer beam 300 is positioned lower than the other outer pin hole 302 on the same horizontal side 306 of the outer beam 300. The vertical distance between the outer pin holes 302 and the vertical distance between the outer snap pins 122 are dependent on the angle of curvature of the outer beam 300. A higher degree of curvature of the outer beam 300 would lead to a greater vertical offset. Further, as noted, the end surface 308 is configured to abut the lip 130 of the adapter 100 when the outer snap pins 122 of the adapter 100 are engaged with the outer pin holes 302 of the outer beam 300.

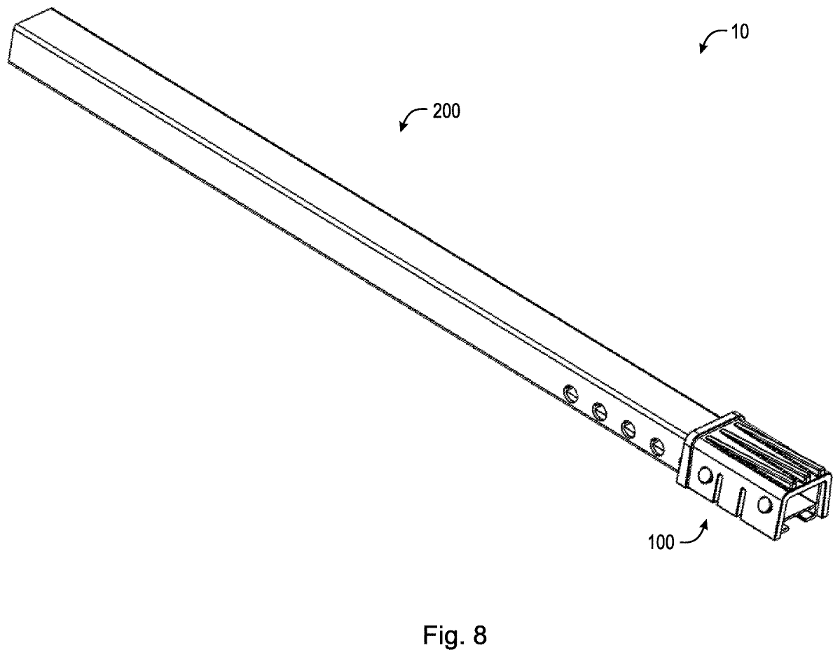

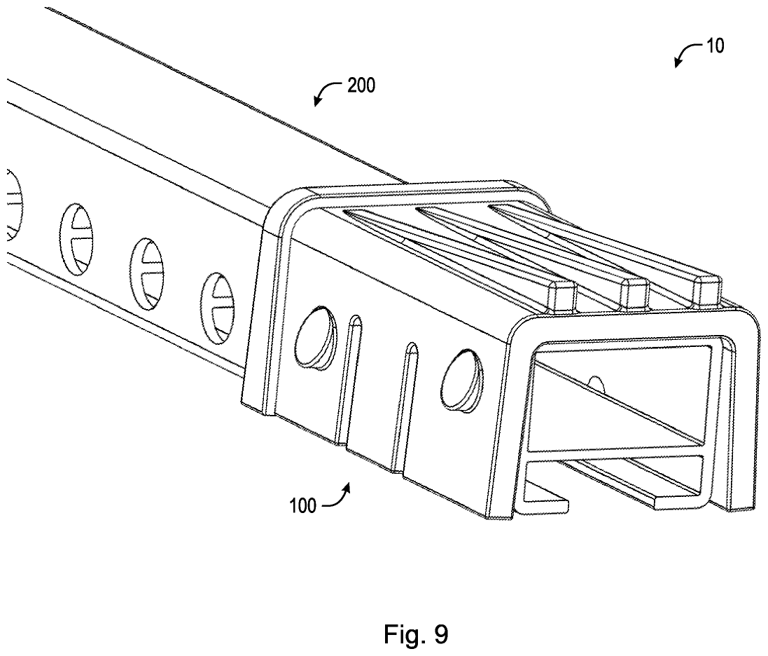

FIG. 7 illustrates an isometric view of an adapter 100 to be coupled with an inner beam 200. As can be seen in FIG. 7, the inverted u-shaped body 102 of the adapter 100 is configured to fit around inner beam 200. Upon insertion of the inner beam 200 into the adapter 100, the one or more inner snap pins 116 of the adapter 100 will engage with the corresponding inner pin holes 302 to couple the adapter 100 to the inner beam 200. The result of this coupling is shown in FIGS. 8 and 9.

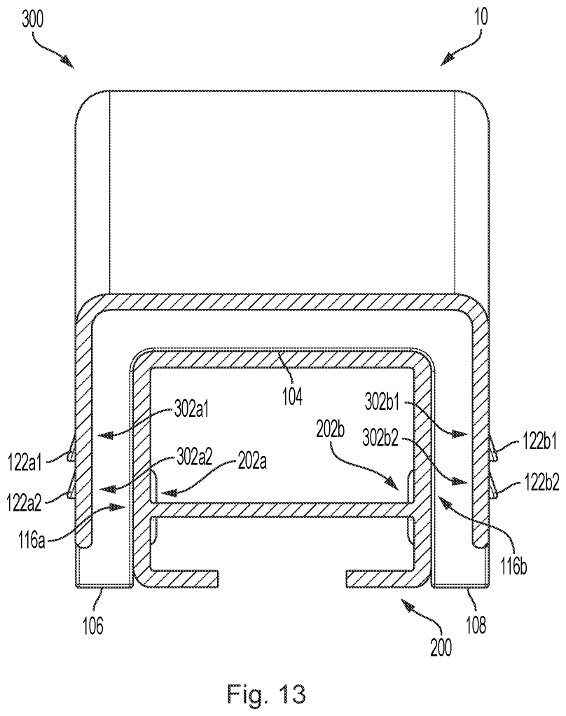

FIG. 10 illustrates a front view of an example crossbeam assembly 10. In this example crossbeam assembly 10, an adapter 100 has been coupled to an inner beam 200 as described with reference to FIGS. 7-9. As shown in FIG. 10, the inner beam 200 has been inserted into the channel 110 of the inverted u-shaped body 102 of the adapter 100. Further, inner snap pins 116a, 116b of the adapter 100 have engaged with inner pin holes 202a, 202b of the inner beam 200. FIG. 10 further illustrates that the angle formed between the horizontal side 104 and the vertical sides 106, 108 of the adapter 100 is greater than ninety degrees, as previously discussed. As will be demonstrated in FIG. 13, this angle will decrease with the coupling of the outer beam 300 to the adapter 100, as the outer beam 300 inwardly biases the vertical sides 106, 108 of the adapter 100.

FIG. 11 illustrates an isometric view of a crossbeam assembly 10 wherein an adapter 100 is coupled to a straight inner beam 200 and is about to couple with a curved outer beam 300. As can be seen in FIG. 11, the width of the outer beam 300 is greater than both the adapter 100 and the inner beam 200. Further, as shown in FIG. 6, the outer beam includes an open lower channel 304. Thus, the outer beam 300 is configured to fit around both the adapter 100 and the straight inner beam 200, specifically abutting the adapter 100 and being spaced from the inner beam 200 by a thickness of the adapter 100. Upon insertion of the adapter 100 and the inner beam 200 into the outer beam 300, the plurality of outer snap pins 122 of the adapter 100 will engage with the corresponding outer pin holes 302 of the outer beam 300 to couple the adapter 100 to the outer beam 300. Additional support and reinforcement for this engagement is provided by the ramps 132 and the lip 130 of the adapter 100. The result of this coupling is illustrated in FIG. 12. FIG. 12 further illustrates an end surface 308 of the outer beam 300 meeting the lip 130 of the adapter 100 to further reinforce the coupling of the adapter 100 to the outer beam 300.

FIG. 13 illustrates a front view of an example crossbeam assembly 10. In this example crossbeam assembly 10, an outer beam 300 has been coupled to an adapter 100 as described with reference to FIGS. 11 and 12. As shown in FIG. 13, the adapter 100 and the inner beam 200 have been inserted into the outer beam 300. Further, outer snap pins 122a1, 122a2, 122b1, 122b2 of the adapter have engaged with the outer pin holes 302a1, 302a2, 302b1, 302b2 of the outer beam 300. FIG. 13 further illustrates the outer beam 300 biasing the vertical sides 106, 108 of the adapter 100 towards the inner beam 200. This biasing results in the angles formed between the vertical sides 106, 108 and the horizontal side 104 to be about ninety degrees. This biasing further secures the adapter 100 to the inner beam 200 by reinforcing the engagement of the inner snap pins 116a, 116b of the adapter 100 with the inner pin holes 202a, 202b of the inner beam 200.

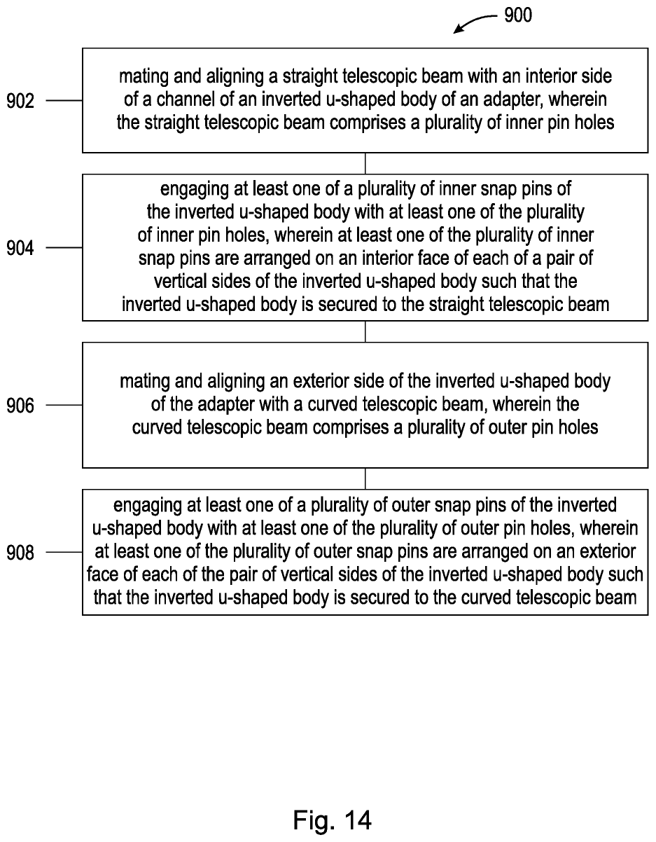

FIG. 14 is a flowchart of a method 900 for manufacturing a crossbeam assembly, such as the crossbeam assembly 10 shown in FIGS. 1 and 13 by way of example. Referring to FIGS. 1-14, the method 900 includes a step 902 of mating and aligning a straight telescopic beam 200 with an interior side 112 of a channel 110 of an inverted u-shaped body 102 of an adapter 100. The straight telescopic beam 200 includes a plurality of inner pin holes 202.

The method 900 further includes a step 904 of engaging at least one of a plurality of inner snap pins 116 of the inverted u-shaped body 102 with at least one of the plurality of inner pin holes 202. At least one of the plurality of inner snap pins 116 are arranged on an interior face 118, 120 of each of a pair of vertical sides 106, 108 of the inverted u-shaped body 102 such that the inverted u-shaped body 102 is secured to the straight telescopic beam 200.

The method 900 further includes a step 906 of mating and aligning an exterior side 124 of the inverted u-shaped body 102 of the adapter 100 with a curved telescopic beam 300. The curved telescopic beam 300 comprises a plurality of outer pin holes 302.

The method 900 further includes a step 908 of engaging at least one of a plurality of outer snap pins 122 of the inverted u-shaped body 102 with at least one of the plurality of outer pin holes 302. At least one of the plurality of outer snap pins 122 are arranged on an exterior face 124, 126 of each of the pair of vertical sides 106, 108 of the inverted u-shaped body 102 such that the inverted u-shaped body 102 is secured to the curved telescopic beam 300.

According to an example, upon engaging the at least one of the plurality of outer snap pins 122 of the inverted u-shaped body 102 with the at least one of the plurality of outer pin holes 302, the curved telescopic beam 300 biases the pair of vertical sides 106, 108 of the inverted u-shaped body 102 towards the straight telescopic beam 200, thus sandwiching the adapter 100 between the straight telescopic beam 200 and the curved telescopic beam 300 and locking the crossbeam assembly 10 in place.

While embodiments of the current crossbeam assembly have been described and illustrated in the context of its applicability to tonneau covers, it is contemplated that such crossbeam assemblies have a variety of applications where two beams are coupled together. Such beams may include, for example, a straight beam and a curved beam (as described herein), two straight beams if there is no vertical offset among the pins and holes, or even two curved beams. It can be appreciated that embodiments of the current crossbeam assembly, and in particular the adapter, can be used in several ways to secure multiple beams together.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one” or “one or more” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein, “about” means approximately or nearly, and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

1. An adapter for coupling an inner beam and an outer beam, wherein the outer beam has an inner width that is greater than an outer width of the inner beam, the adapter comprising:
an inverted u-shaped body comprising a horizontal side and a pair of vertical sides forming a channel configured to mate and align with the inner beam at an interior side of the inverted u-shaped body and to mate and align with the outer beam at an exterior side of the inverted u-shaped body;
a plurality of inner snap pins, wherein at least one of the plurality of inner snap pins is arranged on an interior face of each of the pair of vertical sides of the inverted u-shaped body, wherein each of the plurality of inner snap pins is configured to engage with one of a plurality of inner pin holes of the inner beam such that the inverted u-shaped body is secured to the inner beam; and
a plurality of outer snap pins, wherein at least one of the plurality of outer snap pins is arranged on an exterior face of each of the pair of vertical sides of the inverted u-shaped body, wherein each of the plurality of outer snap pins is configured to engage with one of a plurality of outer pin holes of the outer beam such that the inverted u-shaped body is secured to the outer beam.

2. The adapter of claim 1, wherein a top face of each of the plurality of outer snap pins is angled relative to a corresponding one of the pair of vertical sides.

3. The adapter of claim 1, wherein the plurality of inner snap pins is substantially dome-shaped.

4. The adapter of claim 1, wherein the pair of vertical sides of the inverted u-shaped body meet the horizontal side at an angle greater than ninety degrees when the plurality of outer snap pins are disengaged from the plurality of the outer pin holes, wherein said angle between the horizontal side and each of the pair of vertical sides optionally being about 92 degrees to about 110 degrees.

5. The adapter of claim 1, wherein two or more of the plurality of outer snap pins are arranged on one of the pair of vertical sides.

6. The adapter of claim 1, wherein the inner beam is a straight telescopic beam and the outer beam is a curved telescopic beam.

7. The adapter of claim 6, wherein the two or more of the plurality of outer snap pins are vertically offset from each other to accommodate a curve of the curved telescopic beam.

8. The adapter of claim 6, further comprising one or more ramps on an exterior face of the horizontal side of the inverted u-shaped body, the one or more ramps having an angle corresponding to a curve of the curved telescopic beam.

9. A crossbeam assembly, comprising:
a straight telescopic beam comprising a plurality of inner pin holes;
a curved telescopic beam comprising a plurality of outer pin holes; and
an adapter, comprising:
an inverted u-shaped body comprising a horizontal side and a pair of vertical sides forming a channel configured to mate and align with the straight telescopic beam at an interior side of the inverted u-shaped body and to mate and align with the curved telescopic beam at an exterior side of the inverted u-shaped body;
a plurality of inner snap pins, wherein at least one of the plurality of inner snap pins is arranged on an interior face of each of the pair of vertical sides of the inverted u-shaped body, wherein each of the plurality of inner snap pins is configured to engage with one of the plurality of inner pin holes such that the inverted u-shaped body is secured to the straight telescopic beam; and
a plurality of outer snap pins, wherein at least one of the plurality of outer snap pins is arranged on an exterior face of each of the pair of vertical sides of the inverted u-shaped body, wherein each of the plurality of outer snap pins is configured to engage with one of the plurality of outer pin holes such that the inverted u-shaped body is secured to the curved telescopic beam.

10. The crossbeam assembly of claim 9, wherein the adapter is a monolithic structure.

11. The crossbeam assembly of claim 9, wherein the adapter is formed by injection molding or additive manufacturing.

12. The crossbeam assembly of claim 9, wherein the adapter is substantially plastic.

13. The crossbeam assembly of claim 9, wherein the pair of vertical sides of the inverted u-shaped body meet the horizontal side at an angle greater than ninety degrees when the plurality of outer snap pins are disengaged from the plurality of the outer pin holes, and wherein the curved telescopic beam is configured to bias the pair of vertical sides of the inverted u-shaped body towards the straight telescopic beam such that the angle between the horizontal side and each of the pair of vertical sides is approximately ninety degrees.

14. The crossbeam assembly of claim 9, wherein the straight telescopic beam and the curved telescopic beam are substantially metal.

15. The crossbeam assembly of claim 9, wherein a length of the straight telescopic beam is substantially half of a length of the curved telescopic beam.

16. The crossbeam assembly of claim 9, wherein the straight telescopic beam is configured to mechanically couple to a tonneau cover frame.

17. The crossbeam assembly of claim 9, wherein the curved telescopic beam is substantially u-shaped.

18. The crossbeam assembly of claim 9, wherein the curved telescopic beam has an open lower face for receiving the inverted u-shaped body of the adapter.

19. The crossbeam assembly of claim 9, wherein two or more of the plurality of outer snap pins are vertically offset from each other and wherein two or more of the plurality of outer pin holes are vertically offset from each other to correspond to the vertically offset two or more of the plurality of outer snap pins.

20. A tonneau cover assembly comprising a frame, wherein the frame comprises at least one crossbeam assembly of claim 9.

21. The tonneau cover assembly of claim 20, wherein the curved telescopic beam of the at least one crossbeam assembly provides vertical support for a tonneau cover affixed to the frame.

22. A method for manufacturing a crossbeam assembly, comprising:
mating and aligning a straight telescopic beam with an interior side of a channel of an inverted u-shaped body of an adapter, wherein the straight telescopic beam comprises a plurality of inner pin holes;
engaging at least one of a plurality of inner snap pins of the inverted u-shaped body with at least one of the plurality of inner pin holes, wherein at least one of the plurality of inner snap pins are arranged on an interior face of each of a pair of vertical sides of the inverted u-shaped body such that the inverted u-shaped body is secured to the straight telescopic beam;
mating and aligning an exterior side of the inverted u-shaped body of the adapter with a curved telescopic beam, wherein the curved telescopic beam comprises a plurality of outer pin holes; and
engaging at least one of a plurality of outer snap pins of the inverted u-shaped body with at least one of the plurality of outer pin holes, wherein at least one of the plurality of outer snap pins are arranged on an exterior face of each of the pair of vertical sides of the inverted u-shaped body such that the inverted u-shaped body is secured to the curved telescopic beam.

23. The method of manufacturing of claim 22, wherein, upon engaging the at least one of the plurality of outer snap pins of the inverted u-shaped body with the at least one of the plurality of outer pin holes, the curved telescopic beam biases the pair of vertical sides of the inverted u-shaped body towards the straight telescopic beam.
